(19) United States
(12) Patent Application Publication
(10) Pub. No.: US 2026/0230332 A1
(43) Pub. Date: Aug. 6, 2026

(54) IDENTIFICATION POWER CHIP FOR GRID-INTEGRATED ENERGY DEVICES

(71) Applicant: L&T Semiconductor Technologies Limited, Mumbai (IN)

(72) Inventors: Andres Carvallo, Kyle, TX (US); Vibhu Sharma, Austin, TX (US)

(21) Appl. No.: 19/419,240

(22) Filed: Dec. 15, 2025

Related U.S. Application Data
(60) Provisional application No. 63/734,638, filed on Dec. 16, 2024.

(51) Int. Cl. H04L 9/32; H04L 9/14

(52) U.S. Cl. CPC H04L 9/3263; H04L 9/14

(57) ABSTRACT

Embodiments herein provide an identification power chip for authenticating an energy device on a grid entity. The identification power chip comprises a processing element to receive a plurality of electrical parameters from a data acquisition module. The processing element may obtain a digital certificate based on a unique identifier (UID) of the energy device. The processing element may determine a communication protocol compatible with the grid entity and transmit the plurality of electrical parameters, the UID, and the obtained digital certificate to the grid entity. The processing element may receive a challenge message from the grid entity based on the transmission and transmit a signed message to the grid entity using a private key associated with the digital certificate, wherein the signed message is verifiable using a public key in the digital certificate.

### PRIORITY PARAGRAPH

This application claims priority to US Provisional Patent 63/734,638 filed on December 16, 2024, which is incorporated herein by reference in its entirety.

### BACKGROUND

### Technical Field

Embodiments herein generally relate to a semiconductor, and more particularly to an identification power chip for grid-integrated energy devices.

### Description of the Related Art

The integration of distributed energy resources (DERs), smart meters, and various consumer and industrial appliances into modern smart grids has become a critical challenge for energy management systems. The proliferation of these devices, each with unique operational characteristics, has introduced significant complexity in managing, monitoring, and optimizing energy flows across electric grids. As a result, ensuring secure, reliable, and standardized communication between energy devices and grid management systems such as Supervisory Control and Data Acquisition (SCADA), Advanced Distribution Management Systems (ADMS), Distributed Energy Resource Management Systems (DERMS), and Energy Management Systems (EMS) has become a priority for electric utilities and grid operators.

Traditionally, energy devices have required manual configuration or external identification systems to register their characteristics with grid management systems. This approach has resulted in inefficiencies, particularly in the deployment of distributed energy resources (DERs) like solar inverters and energy storage systems, where the need for rapid and autonomous device identification is paramount. Additionally, the variety of communication protocols employed by different grid systems, such as IEC 61850, IEEE 2030.5, DNP3, and Modbus, has created interoperability challenges. Energy devices are often constrained to a single protocol or require extensive customization to communicate with diverse grid systems.

Further complicating the integration process is the critical requirement for robust cybersecurity. As energy devices increasingly interact with grid systems, ensuring the authenticity and integrity of data transmissions is essential. Unsecured communication between devices and grid management systems exposes critical infrastructure to malicious attacks, such as data tampering or unauthorized access, potentially leading to significant disruptions.

To address these challenges, there is a need for a chip that can overcome drawbacks and disadvantages of existing solutions, which are limited in scope, focusing on specific grid architectures, or lack the multi-protocol flexibility and robust cybersecurity measures required for future smart grid applications.

### SUMMARY

Embodiments herein generally relate to a semiconductor, and more particularly to an identification power chip for energy devices.

An aspect of the present disclosure relates to an identification power chip for authenticating an energy device on a grid entity. The identification power chip comprises a processing element. The processing element may receive a plurality of electrical parameters associated with the energy device from a data acquisition module. The processing element may obtain a digital certificate based on a unique identifier (UID) of the energy device. The processing

element may determine a communication protocol compatible with the grid entity. The processing element may transmit the plurality of electrical parameters, the UID, and the obtained digital certificate to the grid entity, according to the determined communication protocol. The processing element may receive a challenge message from the grid entity based on the transmission. The processing element may transmit a signed message to the grid entity using a private key associated with the digital certificate, wherein the signed message is verifiable using a public key in the digital certificate.

In one or more embodiments, the processing element may be configured to encrypt messages transmitted to the grid entity according to the communication protocol using the cybersecurity module

In one or more embodiments, the plurality of electrical parameters may comprise any or a combination of: a device type, device descriptors, voltage, amperage, power quality metrics, power generation metrics, and/or energy consumption patterns.

In one or more embodiments, the processing element may be configured to filter the plurality of electrical parameters using any one or a combination of: a Fourier Transform (FFT), and a Moving Average Filter.

In one or more embodiments, the processing element may be configured to process the plurality of electrical parameters to detect anomalies based on a machine learning model or a statistical model.

In one or more embodiments, the processing element may be configured to execute self-diagnostics comprising any one or a combination of: sensor self-testing, communication checks, security checks, memory and data integrity checks, and power supply checks.

In one or more embodiments, the processing element executes a calibration routine wherein the processing element is to determine a plurality of baseline parameters during an initial setup, compare the plurality of received electrical parameters to the plurality of baseline parameters to identify any inconsistency, deviation or error, and calibrate the plurality of received electrical parameters based on identified inconsistency, deviation, or error.

In one or more embodiments, the processing element executes the calibration routine during an initial setup, and/or periodically based on the received electrical parameters, usage patterns, set intervals, and environmental changes.

In one or more embodiments, the processing element may be configured to format the plurality of electrical parameters into standardized packet structures based on the determined communication protocol.

In one or more embodiments, to determine the communication protocol compatible with the grid entity, the processing element may be configured to scan for a compatible communication protocol using a handshake process.

In one or more embodiments, the communication protocol may comprise at least one of: IEC 61850, IEEE 2030.5, DNP3, or Modbus.

In one or more embodiments, the processing element may be configured to switch the communication protocol in response to communicative coupling of the energy device to a different grid entity.

In one or more embodiments, to obtain the digital certificate, the processing element may be configured to transmit the UID in a request message to a certifying authority (CA) entity, and receive the digital certificate in response to the request message upon verification.

In one or more embodiments, a distributed energy resource (DER) may comprise an identification power chip having a processing element to receive a plurality of electrical parameters associated with the energy device from a data acquisition module and obtain a digital certificate based on a unique identifier (UID) of the energy device (10). The processing element associated with the identification power chip may be configured to determine a communication protocol compatible with the grid entity. The processing element may be configured to transmit the plurality of electrical parameters, the UID, and the obtained digital certificate to the grid entity, according to the determined communication protocol and receive a challenge message from the grid entity based on the transmission. The processing element may be configured to transmit a signed message to the grid entity using a private key associated with the digital certificate, wherein the signed message is verifiable using a public key in the digital certificate.

An aspect of the present disclosure relates to a method for authenticating an energy device on a grid entity, using the identification power chip. The method includes receiving from a data acquisition module associated with a processing element, a plurality of electrical parameters of an energy device, obtaining, using the processing element, a digital certificate based on a unique identifier (UID) of the energy device, determining, using the processing element, a communication protocol compatible with the grid entity, transmitting, using the processing element, the plurality of electrical parameters, the UID, and the obtained digital certificate to the grid entity, according to the determined communication protocol, receiving, using the processing element, a challenge message from the grid entity based on the transmission, and transmitting, using the processing element, a signed message to the grid entity using a private key associated with the digital certificate, wherein the signed message is verifiable using a public key in the digital certificate.

Various objects, features, aspects, and advantages of the present disclosure will become more readily apparent from the following detailed description of exemplary embodiments, in conjunction with the accompanying drawings in which like reference numerals are used to identify corresponding components throughout the views.

### BRIEF DESCRIPTION OF THE DRAWINGS

The accompanying drawings, which are incorporated herein and form a part of the present disclosure, illustrate exemplary embodiments of the disclosed methods and systems. Like reference numerals are used to refer to identical or functionally similar components throughout the different drawings. The components depicted in the drawings are not necessarily drawn to scale; rather, emphasis is placed on clearly illustrating the principles of the present disclosure. In some cases, block diagrams are used to represent components and may not reflect internal circuit-level detail. Those skilled in the art will recognize that such drawings inherently disclose underlying electrical, electronic, or logical circuitry commonly used to implement the illustrated components.

FIG. 1 illustrates an example block diagram of the identification power chip for grid-integrated energy devices, in accordance with an embodiment of the present disclosure.

FIG. 2 illustrates a flow diagram of a method for authenticating an energy device on a grid entity, using the identification power chip, in accordance with an embodiment of the present disclosure.

FIG. 3 illustrates a flow chart of a method for conducting a self-diagnostic test upon system initialization, according to embodiments of the present disclosure.

FIG. 4 is an illustration of an exemplary computer system, according to embodiments of the present disclosure.

The foregoing shall be more apparent from the following more detailed description of the disclosure.

### DETAILED DESCRIPTION OF PREFERRED EMBODIMENTS

The following description sets forth various illustrative embodiments solely to facilitate a thorough understanding of the present disclosure. While specific details are provided for clarity, the disclosed embodiments may be practiced without each of these specific details. Features described herein may be implemented independently or in combination with one another, and not all features are required to address every technical challenge discussed in the background. The examples provided are not intended to limit the scope, applicability, or structure of the present disclosure. Rather, they serve to enable those skilled in the art to implement the claimed subject matter. Modifications in the arrangement, function, or implementation of elements may be made without departing from the scope or spirit of the disclosure as defined by the appended claims.

The following is a detailed description of embodiments of the disclosure depicted in the accompanying drawings. The embodiments are in such detail as to clearly communicate the disclosure. If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, the term “processing element” refers to and includes one or more modules configured to perform processing functions within the identification power chip. The processing element includes electronic circuitry, which may include one or more IP cores or agents. Such processing elements may be fabricated on a semiconductor chip, including a plurality of transistors arranged and electrically connected to communicate with each other so as to perform one or more intended functions. The processing element is configured to process data, control operations, and execute instructions to enable the functionality of the identification power chip.

As used herein, the term “Intellectual Property cores” or “IP cores” refers to a reusable unit of logic or functionality for e.g. a block of circuitry, a processor core, or a controller, designed to be integrated into semiconductor chips. IP cores may be hardware designs or layout representations that perform specific functions and may be licensed or reused to accelerate chip development.

An aspect of the present disclosure relates to an identification power chip for authenticating an energy device on a grid entity. The identification power chip includes a processing element. The processing element may include or be coupled to a data acquisition module, a processing module, a communication module, a cybersecurity module, and a self-diagnostic module. The processing element may receive a plurality of electrical parameters associated with the energy device from a data acquisition module. The processing element may obtain a digital certificate based on a unique identifier (UID) of the energy device. The processing element may determine a communication protocol compatible with the grid entity. The processing element may transmit the plurality of electrical parameters, the UID, and the obtained digital certificate to the grid entity, according to the determined communication protocol. The processing element may receive a challenge message from the grid entity based on the transmission of the plurality of electrical parameters, the UID, and/or the obtained digital certificate. The processing element may transmit a signed message to the grid entity using a private key associated with the digital certificate, where the signed message is verifiable using a public key in the digital certificate.

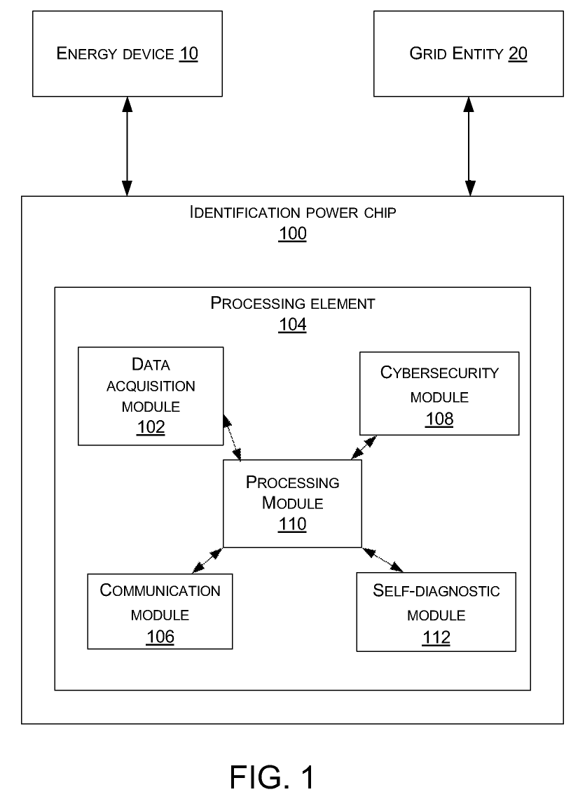

The present disclosure provides an identification power chip and a method for authenticating an energy device on a grid entity. Hereafter, the identification power chip for authenticating energy device on a grid entity, will be referred to as “identification power chip” and method for authenticating an energy device on a grid entity, using the identification power chip, will be referred to as “method”. The various embodiments throughout the disclosure will be explained in more detail with reference to FIGS. 1-4.

FIG. 1 illustrates an exemplary block diagram of the identification power chip for grid-integrated energy devices, in accordance with an embodiment of the present disclosure. An energy device 10 may include distributed energy resources (DERs). DERs may be a small-scale, localized energy device near consumers that generates, stores, or manages electricity. DERs may include rooftop solar panels, small wind turbines, battery storage, fuel cells, small hydropower units, and electric vehicles.

In one or more embodiments, the DERs may be coupled/connected to a grid entity, such as grid entity 20. The grid entity 20 may include any or a combination of an electric utility, a power grid, a plurality of grid operators, a grid management system, or a plurality of third-party aggregators. The power grid/grid entity 20 may include a supervisory control and data acquisition (SCADA) systems, advanced distribution management systems (ADMS), distributed energy resource management systems (DERMS), and energy management systems (EMS).

In one or more embodiments, the energy device 10 may include an identification power chip 100 embedded therein. The identification power chip 100 may include a chip, or a semiconductor system on a chip (SoC). The identification power chip 100 may include a processing element 104. In one or more embodiments, the processing element 104 may include or be coupled to at least one of a data acquisition module 102, a communication module 106, a cybersecurity module 108, a processing module 110, and a self-diagnostic module 112.

In one or more embodiments, the identification power chip 100 may include data acquisition module 102. The data acquisition module 102 may be configured to receive a plurality of electrical parameters associated with the energy device 10. The plurality of electrical parameters may include but not limited to a device type, device descriptors, voltage, amperage, power quality metrics, power generation metrics, and/or energy consumption patterns, for use in autonomous identification by grid entity 20. The data acquisition module 102 may include one or more sensors that may be configured to measure electrical parameters associated with the energy device 10. For measuring electrical parameters like voltage and amperage, the data acquisition module 102 may employ specialized transducers such as Current Transformers (CTs) and Voltage Transformers (VTs), which safely measure electrical flow without direct contact. To determine power quality metrics, the data acquisition module 102 may use the raw data from the sensors and process the data with a dedicated processing element 104, which may use a fast Fourier transform (FFT) to analyse waveform distortions like harmonics. For power generation and energy consumption patterns, the data acquisition module 102 may use advanced filtering algorithms to integrate real-time voltage and current measurements over time, effectively acting as an advanced energy meter. For obtaining device’s type and descriptors, the data acquisition module 102 may rely on a combination of a pre-programmed unique identifier (UID) and a sophisticated analysis of the device’s unique electrical signature, which is a specific pattern of electrical usage and characteristics. The plurality of sensors may also sense the internal environment of the grid entity 20 and one or more parameters associated with the energy device 10. The plurality of sensors may include integrated circuits and on-chip sensors for intelligent self-identification service. The sensors may be communicatively connected with the identification power chip 100. The sensors may be configured for transmitting data or values associated with the energy device 10 and the grid entity 20.

In one or more embodiments, the processing element 104, either through or at the data acquisition module 102, may be configured to process electrical characteristics using advanced filtering algorithms such as Fourier Transform (FFT) for power quality analysis and predictive analytics to detect anomalies in power usage or potential device failures. The data acquisition module 102 may utilize a combination of filtering algorithms, for e.g., digital filters to reduce noise, and real-time data analytics to process the captured electrical characteristics. The filtering algorithm may include a Fourier Transform (FFT) to analyze harmonic content and power quality and/or a Moving Average Filter to analyse smooth voltage and current readings over time.

In some embodiments, the identification power chip 100 may include processing module 110, which may be used by the processing element 104 to execute different operations. The processing element 104 may receive a plurality of electrical parameters associated with the energy device 10 from the data acquisition module 102. The processing element 104 may obtain a digital certificate based on a unique identifier (UID) of the energy device 10 and determine a communication protocol compatible with the grid entity 20. The processing element 104 may transmit the plurality of electrical parameters, the UID, and the obtained digital certificate to the grid entity 20, according to the determined communication protocol. The processing element 104 may receive a challenge message from the grid entity 20 based on the transmission and transmit a signed message to the grid entity 20 using a private key associated with the digital certificate, where the signed message is verifiable using a public key in the digital certificate.

In one or more embodiments, the processing element 104 may perform self-diagnostics and calibration to maintain accurate device identification and power characteristics over time, such as using the self-diagnostic module 112. The processing element 104 may perform calibration through an embedded calibration routine within the identification power chip 100, which can be either a one-time or periodic process. During the initial setup, the processing element 104 may be configured to perform a one-time calibration, which typically establishes a plurality of baseline parameters for energy device 10 identification and power characteristics. For periodic recalibration, the identification power chip 100 may compare the formatted electrical parameters obtained in real time against predefined thresholds to set a baseline for each of the electrical parameters (such as voltage and current). This periodic recalibration may be triggered by usage patterns or set intervals, ensuring the energy device 10 adjusts to evolving environmental conditions, including changes in temperature and load variations, over time.

In some embodiments, the identification power chip 100 may include communication module 106. The communication module 106 may be included in or coupled to or operated by the processing element 104. The communication module 106 may support and dynamically switch between multiple standardized communication protocols, including but not limited to IEC 61850, IEEE 2030.5, DNP3, and Modbus, for interoperability with various grid management systems. The communication module 106 may include a protocol detection module 106A. Upon initial connection to or during ongoing communication with the grid entity 20, the protocol detection module (not shown) may be configured to automatically identify the protocol requirements of the grid entity 20, by scanning for supported communication protocols, including but not limited to IEC 61850, IEEE 2030.5, DNP3, and Modbus. Upon identification of the communication protocol, the communication module 106 may perform a communication protocol handshake process to establish a secure and compatible communication link. For example, a distributed energy resource (DER) like a solar inverter may be connected to a local utility that uses IEC 61850 for substation automation. When the communication module 106 initiates communication with the utility’s SCADA system, the protocol detection module detects the IEC 61850 protocol via initial handshaking and selects this protocol for data exchange. Subsequent transmissions from the device 10 to the grid entity may be executed according to the selected protocol.

In one or more embodiments, the communication module 106 and/or the processing element 104 may be configured to switch the communication protocol in response to communicative coupling of the energy device to a different grid entity. In the foregoing example, if the same solar inverter is connected to another system using IEEE 2030.5 (e.g., commonly used for smart grid applications), the communication module 106 may switch to this protocol to ensure seamless communication. The communication module 106 may include an adaptable communication interface (not shown) that can switch between different protocols based on the grid entity 20 that it is interacting with.

In some embodiments, the communication module 106 may transmit the electrical parameters, along with a unique identifier (UID) and a digital certificate, for identification of the energy device 10 by the grid entity 20.

In some embodiments, the identification power chip 100/processing element 104 may include cybersecurity module 108. The cybersecurity module 108 may authenticate the energy device 10 within the power grid 20 through a cryptographic challenge-response mechanism based on its UID and digital certificate issued by a trusted certificate authority. The cybersecurity module 108 embedded within the identification power chip 100 may provide advanced security features to safeguard the integrity of the transmitted data. The cybersecurity module 108 may also implement multi-layered security features such as data encryption using cryptographic algorithms like Advance Encryption Standards (AES), secure authentication via Public Key Infrastructure (PKI), and secure boot to ensure that data is protected from unauthorized access and tampering. During communication, the unique identifier and digital certificate may be used to authenticate the energy device 10 with the grid entity 20, by verifying the cryptographic signature, thereby ensuring that only authorized energy devices 10 can transmit data. For example, initially, the grid entity 20 initiates an authentication process by sending a challenge message to the identification power chip 100. In response, the identification power chip 100 responds by signing a (challenge) message with the private key of the energy device 10 (i.e., the private key associated with the digital certificate). The grid entity 20 verifies the response from the identification power chip 100, using the public key embedded in the digital certificate associated with the unique identifier (UID) of the energy device 10.

In some embodiments, the identification power chip 100 may integrate an analog-to-digital converter (ADC) for precise measurement of electrical characteristics, and support a range of energy devices 10 including distributed energy resources (DERs) (e.g., solar inverters, battery storage systems), smart meters, and consumer appliances, enabling widespread compatibility with both legacy and modern smart grid infrastructures.

In some embodiments, the identification power chip 100 may include the processing module 110. Among other functions, the processing module 110 may be configured to analyze real-time data from the data acquisition module 102. The real-time data analytics may implement a predictive model. The predictive model may include a machine learning mode or statistical model to detect anomalies in power usage or potential device failures, enhancing device reliability and performance through proactive monitoring. The processing module 110 may format the data in accordance with standardized communication protocols, for communication in standardized packet structures based on the selected communication protocol, including GOOSE messages for IEC 61850 or register-based formats for Modbus, thereby ensuring seamless interoperability across protocols while preserving core energy device 10 metrics. Each communication protocol uses a specific data structure, but the core data such as a device type, voltage, amperage, and power quality metrics that are embedded within the data packet remain consistent. For instance, in IEC 61850, data is organized into generic object-oriented substation event (GOOSE) messages to support event-driven communication, whereas in Modbus, the data is formatted as registers for periodic polling. Regardless of the communication protocol used, these core electrical characteristics/data associated with the energy device 10 are packaged into a standardized format aligned with the selected communication protocol, thereby ensuring effective interoperability across systems.

In some embodiments, the identification power chip 100 may include self-diagnostic module 112. The self-diagnostic module 112 performs automated tests on the sensors, the communication module 106, and the cybersecurity module 108 encryption systems during startup to ensure operational integrity, including sensor functionality, communication readiness, and security compliance. The self-diagnostic module 112 may (self-)test the sensors to ensure that voltage, amperage, and other sensors are functional. The self-diagnostic module 112 may verify that the communication module 106 (e.g., supporting IEC 61850, Modbus, etc.) is operational during a communication check. The self-diagnostic module 112 may verify the integrity of the encryption and authentication systems (e.g., verifying that the secure boot process has not been compromised), during security checks. The self-diagnostic module 112 may verify that the internal memory and storage are intact, during memory and data integrity checks. The self-diagnostic module 112 may monitor internal voltage regulators to ensure the semiconductor identification power chip 100 is receiving the correct power levels, during power supply checks.

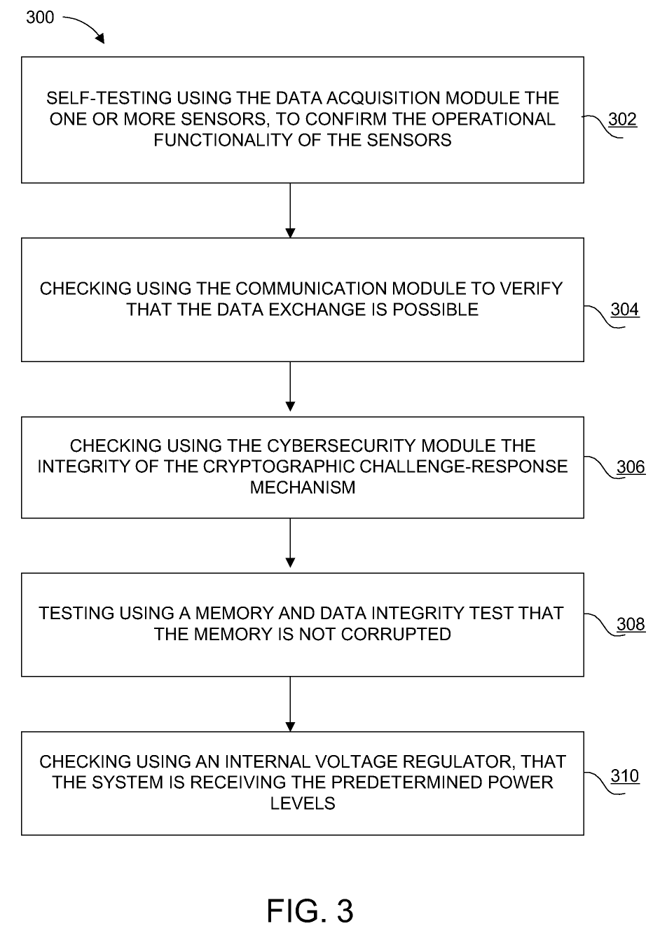

In an embodiment, the identification power chip 100 may include self-diagnostic module 112, to perform self-diagnostic routine 300 each time the identification power chip 100 is initialized, or during first set-up, as shown in FIG. 3. The self-diagnostic routine 300 may include a self-test of the sensors, a communication check, a security check to verify the integrity of the cryptographic mechanism, a memory test to ensure that the memory is not corrupted, and a power supply check to ensure the identification power chip 100 is receiving the correct power levels. In other embodiments, the self-test routine and/or calibration routine may be executed periodically based on the received electrical parameters, usage patterns, set intervals, and environmental changes, but not limited thereto.

In some embodiments, the identification power chip 100 may be a standardized, secure, and interoperable chip that can autonomously identify energy devices, dynamically adapt to various communication protocols, and ensure the security of transmitted data. The identification power chip 100 may enable energy devices 10 to autonomously identify themselves to various grid entities 20 including grid management systems, such as Supervisory Control and Data Acquisition (SCADA), Advanced Distribution Management Systems (ADMS), Distributed Energy Resource Management Systems (DERMS), and Energy Management Systems (EMS). This identification process may securely transmit important power and energy characteristics, including voltage, amperage, and power quality, via multiple standardized communication protocols. The identification power chip 100 also includes advanced encryption and authentication mechanisms, ensuring secure, real-time communication with grid entities 20 including electric utilities, grid operators, and third-party energy aggregators.

In some embodiments, an architecture of the identification power chip 100 may integrate the data acquisition module 102, the processing element 104, the communication module 106, and the cybersecurity module 108 and may support dynamic switching between multiple communication protocols such as IEC 61850, IEEE 2030.5, DNP3, and Modbus, thereby ensuring compatibility with both legacy and modern grid systems. Security features include encryption based on the Advanced Encryption Standard (AES), secure authentication using Public Key Infrastructure (PKI), and a unique digital identifier for each chip. These measures ensure secure, authenticated communication between energy devices and grid management systems, protecting against unauthorized access and data tampering.

In some embodiments, the identification power chip 100 may significantly improve integration of the energy device 10 by enabling seamless communication with grid entities 20, enhancing grid security, and ensuring compatibility with diverse grid infrastructures. The identification power chip 100 may simplify deployment and management of the energy device 10, making it indispensable for modern and future smart grids.

In some embodiments, the identification power chip 100 may autonomously identify the energy devices 10 to the grid entities 20, using dynamic communication protocols and facilitate real-time, secure communication through advanced encryption and authentication mechanisms. The self-diagnostics, recalibration, and multi-layered cybersecurity features of the identification power chip 100 may be a distinguishing feature relative to the prior solutions, and ensure compatibility across both legacy and modern grid systems while maintaining high data integrity and reliability. The identification power chip 100 may provide a scalable solution, embedding seamlessly within any grid-connected device to enable streamlined integration with grid management systems.

In some embodiments, the identification power chip 100 may integrate autonomous energy device 10 identification, real-time data processing, multi-protocol communication, and advanced cybersecurity features, and provide substantial benefits to the grid entity 20, in terms of device integration, management, and security. Through autonomous identification capabilities, the identification power chip 100 may enable energy devices 10 to automatically transmit essential parameters such as voltage, amperage, and power quality to the grid entity 20 without the need for manual setup.

In some embodiments, the identification power chip 100 may be engineered for low-power consumption to minimize the impact on the energy usage of the energy device 10. The power consumption of the identification power chip 100 varies based on processing and communication demands, typically ranging from a few milliwatts in standby mode to a couple of watts when active. This efficient power profile ensures that the identification power chip 100 does not significantly influence the host device’s overall energy usage. In energy-sensitive applications, such as distributed energy resources (DERs) or smart meters, the chip’s power-saving features including sleep modes, and low-power data transmission, enable the host energy device 10 to operate efficiently without compromising communication capabilities.

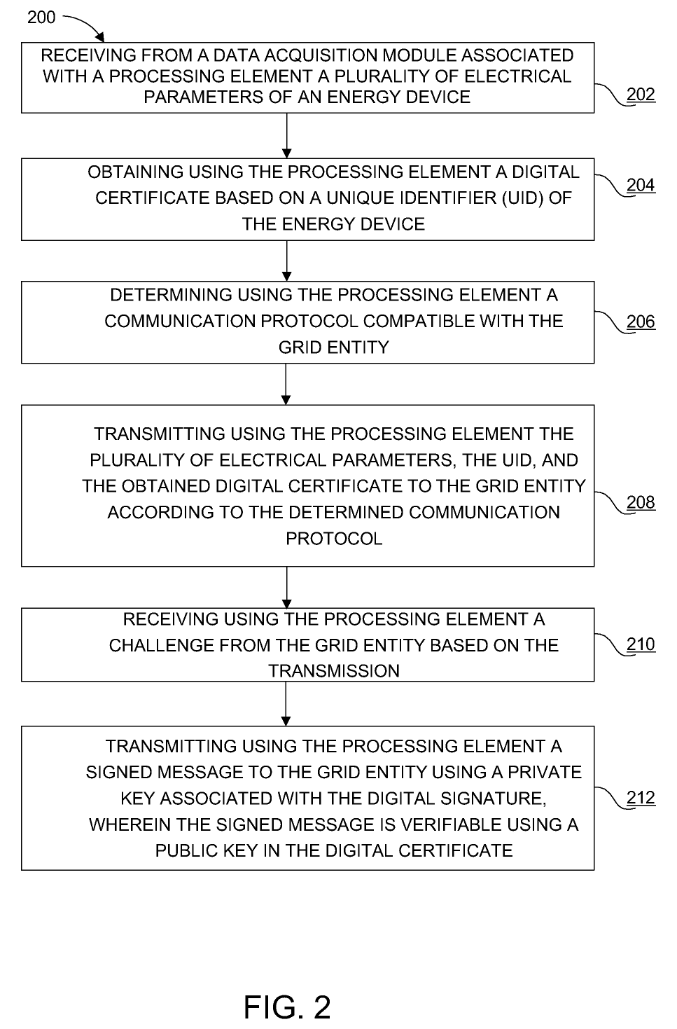

FIG. 2 illustrates an exemplary flow diagram of a method for authenticating an energy device on a grid entity, using the identification power chip of FIG. 1, in accordance with an embodiment of the present disclosure.

With reference to FIG. 2, the method 200 may include one or more steps for authenticating an energy device 10 on a grid entity 20 using an identification power chip 100. The method 200 may be performed by a processing element 104 associated with the identification power chip 100. At a step 202, the method 200 may include receiving from a data acquisition module 102 associated with the processing element 104 of an identification power chip 100, a plurality of electrical parameters of the energy device 10. At a step 204, the method 200 may include obtaining, by the processing element 104, a digital certificate based on a unique identifier (UID) of the energy device 10. At a step 206, the method 200 may include determining, by the processing element 104, a communication protocol compatible with the grid entity 20. At a step 208, the method 200 may include transmitting, by the processing element 104, the plurality of electrical parameters, the UID, and the obtained digital certificate to the grid entity 20, according to the determined communication protocol. At a step 210, the method 200 may include receiving, by the processing element 104, a challenge message from the grid entity 20 based on the transmission. At a step 212, the method 200 may include transmitting, by the processing element 104, a signed message to the grid entity 20 using a private key associated with the digital certificate, wherein the signed message is verifiable using a public key in the digital certificate.

The identification power chip 100 may autonomously identify energy/host devices 10 to the grid entities 20 using dynamic communication protocols and facilitate real-time, secure communication through advanced encryption and authentication mechanisms. The identification power chip 100 may perform self-diagnostics, recalibration, and multi-layered cybersecurity which distinguishes the identification power chip 100 from prior art solutions, and ensures compatibility across both legacy and modern grid systems while maintaining high data integrity and reliability. The identification power chip 100 may provide a scalable solution, embedding seamlessly within any grid-connected device to enable streamlined integration with the grid entity 20. The identification power chip 100 may be versatile and well-suited for various applications, ranging from residential smart meters to large-scale industrial Distributed Energy Resources (DERs). The identification power chip 100 can be integrated into new devices or retrofitted into existing equipment to facilitate seamless smart grid connectivity.

FIG. 3 illustrates a flow diagram for implementing a method 300 for performing self-diagnostic routine, upon identification power chip 100 initialization, according to embodiments of the present disclosure. The processing element 104 may be configured to execute self-diagnostics comprising any one or a combination of: self-testing sensors, communication checks, security checks, memory and data integrity checks, and power supply checks.

With reference to FIG. 3, the method 300 includes one or more steps for performing a self-diagnostic routine during each initialization of the identification power chip 100. These steps are executed by the processing element 104 or the self-diagnostic module 112 associated with the identification power chip 100. At step 302, the method 300 performs self-testing via the processing element 104/self-diagnostic module 112 by receiving a plurality of electrical parameters from one or more sensors through the data acquisition module 102 and verifying the measurements to confirm sensor operational functionality. At step 304, the method 300 verifies data exchange through the communication protocol using the communication module 106, facilitated by the processing element 104. At step 306, the method 300 employs the cybersecurity module 108 to validate the integrity of the cryptographic challenge-response mechanism via the processing element 104. At step 308, the method 300 conducts a memory and data integrity test to ensure the memory is not corrupted, leveraging the processing element 104. At step 310, the method 300 verifies, using an internal voltage regulator, that the identification power chip 100 receives the predetermined power levels.

In some embodiments, the identification power chip 100 may support periodic or event-driven updates to the power grid 20, to ensure that the most current data is always available.

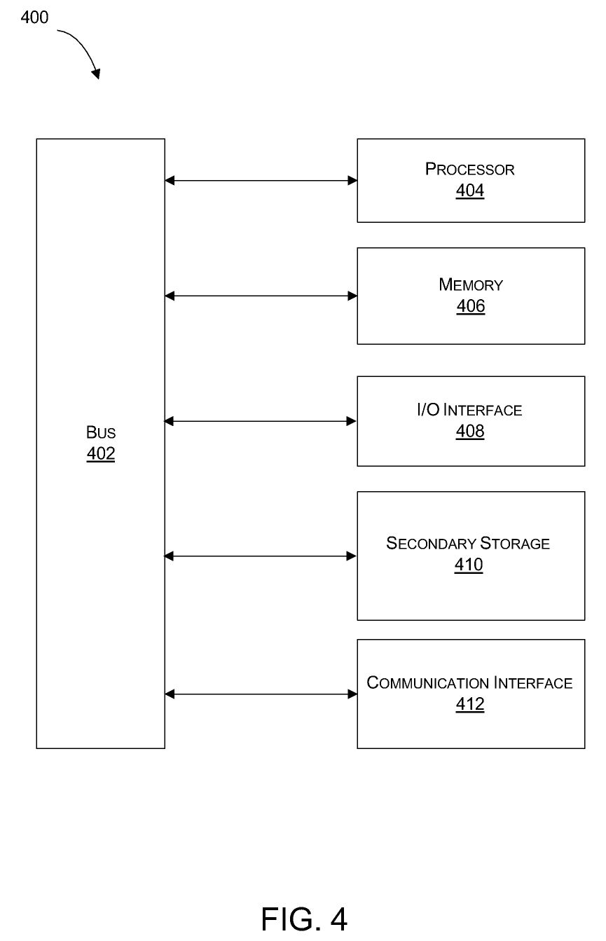

FIG.4 is an illustration of a computer system in which the various architectures and functionalities of implementing the identification power chip 100. For instance, the identification power chip 100 may be implemented as a System on Chip or a part of a computer system 400. As shown, the computer system 400 includes at least one processor 404 that is connected to a bus 402, where the computer system 400 may be implemented using any suitable protocol, such as PCI (Peripheral Component Interconnect), PCI-Express, AGP (Accelerated Graphics Port), Hyper Transport, or any other bus or point-to-point communication protocol(s). The computer system 400 also includes a memory 406.

Control logic (software) and data may be stored in the memory 406, which may take a form of random-access memory (RAM). In the disclosure, a single semiconductor platform may refer to a sole unitary semiconductor-based integrated circuit or chip. It should be noted that the term “single identification power chip 100” may also refer to multi-chip modules with increased connectivity that simulates on-chip modules with increased connectivity which simulate on-chip operation, and make substantial improvements over utilizing a conventional central processing unit (CPU) and bus implementation. Various modules of the identification power chip 100 may also be situated separately or in various combinations of semiconductor platforms per the desires of the user.

The computer system 400 may also include a secondary storage 410. The secondary storage 410 may include, for example, a hard disk drive and a removable storage drive, representing a floppy disk drive, a magnetic tape drive, a compact disk drive, digital versatile disk (DVD) drive, recording device, universal serial bus (USB) flash memory. The removable storage drives may perform at least one of reading from and writing to a removable storage unit in a well-known manner.

Computer programs, or computer control logic algorithms, may be stored in at least one of the memory 406 and the secondary storage 410. Such computer programs, when executed, may enable the computer system 400 to perform various functions as described in the foregoing. The memory 406, the secondary storage 410, and any other storage are possible examples of computer-readable media.

In an implementation, the architectures and functionalities depicted in the various previous figures may be implemented in the context of the processor 404, a graphics processor coupled to a communication interface 412, an integrated circuit (not shown) that is capable of at least a portion of the capabilities of both the processor 404 and a graphics processor, a chipset (namely, a group of integrated circuits designed to work and sold as a unit for performing related functions, and so forth).

Furthermore, the architectures and functionalities depicted in the various previous described figures may be implemented in a context of a general computer system, a circuit board system, a game console system dedicated for entertainment purposes, an application-specific system. For example, the computer system 400 may take the form of a desktop computer, a laptop computer, a server, a workstation, a game console, an embedded system.

Furthermore, the computer system 400 may take the form of various other devices including, but not limited to a personal digital assistant (PDA), a mobile phone, a smart phone, a television, and so forth. Additionally, although not shown, the computer system 400 may be coupled to a network (for example, a telecommunications network, a local area network (LAN), a wireless network, a wide area network (WAN) such as the Internet, a peer-to-peer network, a cable network, or the like) for communication purposes through an I/O interface 408.

In some exemplary embodiments, when a distributed energy resource (DER) such as a solar inverter with the identification power chip 100 is turned on and begins operating, the following sequence of events will occur to ensure a secure and seamless connection to the power grid 20. When the solar inverter, equipped with the identification power chip 100, is turned on, a precise sequence of events ensures that the solar inverter can connect to the power grid 20 safely and efficiently. The process begins with the self-diagnostic module 112 of the identification power chip 100 performing a comprehensive self-check. The self-diagnostic routine verifies that all internal components including the sensors and communication module 106 to the cybersecurity module 108 are working correctly, ensuring the identification power chip 100 is ready for operation. The data acquisition module 102 acquires data from the sensors and provides to the processing module 110 to initiate a calibration routine. The processing module 110 analyses the inverter’s real-time electrical data such as voltage and amperage and compares the values against a set of predefined benchmarks. By comparing, the processing module 110 establishes a reliable baseline for the inverter's performance. The baseline is essential for solar device to accurately identify the power grid 20 and the associated characteristics. The communication module 106 takes over to connect to the power grid 20 and initiate a connection with a local utility’s SCADA system, the identification power chip 100 installed within the solar inverter may initiate a handshake process. The handshaking process allows the system 100 to detect that the utility system utilizes the IEC 61850 protocol for substation automation. In response, the identification power chip 100 automatically selects and switches to the detected/determined protocol i.e. IEC 61850 protocol in the case, for all data exchange. If the same inverter were to connect to a different grid system that uses IEEE 2030.5 for smart grid applications, the identification power chip 100 may again detect the protocol and seamlessly may switch to IEEE 2030.5 protocol, ensuring continuous and compatible communication.

Once the communication protocol is determined, the cybersecurity module 108 authenticates the solar inverter through a cryptographic challenge-response mechanism using the UID and a digital certificate of the solar inverter. In the cryptographic challenge-response mechanism, the power grid 20 sends a challenge message to the solar inverter, to which the identification power chip 100 installed/embedded within the solar inverter responds with a signed message using a private key. The power grid 20 verifies the signature using the public key from the digital certificate associated with the UID. Upon verification, a secure link is established between the solar inverter and power grid 20. The processing module 110 formats the data of the solar inverter into the correct packet structure, and the communication module 106 transmits this formatted information, over the communication protocol IEC 61850 and thus allows the solar inverter to be fully and securely identified by the power grid 20.

Therefore, the proposed identification power chip and method enable an energy device to autonomously and securely communicate the operational characteristics to various grid management systems, such as a solar inverter reporting its energy generation. The identification power chip 100 overcomes the limitations of traditional systems by providing a single, standardized solution that can automatically adapt to different communication protocols and protect data from cyber threats. In essence, the present disclosure provides a universal digital passport for energy devices, making the integration into modern smart grids more efficient, secure, and interoperable.

It should be understood that the arrangements of components illustrated in the figures described are exemplary and that other arrangement may be possible. It should also be understood that the various system components (and means) defined by the claims, described below, and illustrated in the various block diagrams represent components in some systems configured according to the subject matter disclosed herein. For example, one or more of these system components (and means) may be realized, in whole or in part, by at least some of the components illustrated in the arrangements illustrated in the described figures.

In addition, while at least one of these components are implemented at least partially as an electronic hardware component, and therefore constitutes a machine, the other components may be implemented in software that when included in an execution environment constitutes a machine, hardware, or a combination of software and hardware.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope.

1. An identification power chip for authenticating an energy device on a grid entity, the identification power chip comprising:
a processing element to:
receive a plurality of electrical parameters associated with the energy device from a data acquisition module;
obtain a digital certificate based on a unique identifier (UID) of the energy device;
determine a communication protocol compatible with the grid entity;
transmit the plurality of electrical parameters, the UID, and the obtained digital certificate to the grid entity, according to the determined communication protocol;
receive a challenge message from the grid entity based on the transmission; and
upon receiving the challenge message, transmit a signed message to the grid entity using a private key associated with the digital certificate, wherein the signed message is verifiable using a public key in the digital certificate.

2. The identification power chip of claim 1, wherein the processing element is to encrypt messages transmitted to the grid entity according to the communication protocol using a cybersecurity module.

3. The identification power chip of claim 1, wherein the plurality of electrical parameters comprises any or a combination of: a device type, device descriptors, voltage, amperage, power quality metrics, power generation metrics, and/or energy consumption patterns.

4. The identification power chip of claim 1, wherein the processing element is to filter the plurality of electrical parameters using any one or a combination of: a Fourier Transform (FFT), and a Moving Average Filter.

5. The identification power chip of claim 1, wherein the processing element is to process the plurality of electrical parameters to detect anomalies based on a machine learning model or a statistical model.

6. The identification power chip of claim 1, wherein the processing element is to execute self-diagnostics comprising any one or a combination of: sensor self-testing, communication checks, security checks, memory and data integrity checks, and power supply checks.

7. The identification power chip of claim 6, wherein the processing element executes a calibration routine wherein the processing element is to:
determine a plurality of baseline parameters during an initial setup;
compare the plurality of received electrical parameters to the plurality of baseline parameters to identify any inconsistency, deviation or error; and
calibrate the plurality of received electrical parameters based on identified inconsistency, deviation, or error.

8. The identification power chip of claim 7, wherein the processing element executes the calibration routine:
during an initial setup; and/or
periodically based on the received electrical parameters, usage patterns, set intervals, and environmental changes.

9. The identification power chip of claim 1, wherein the processing module is to format the plurality of electrical parameters into standardized packet structures based on the determined communication protocol.

10. The identification power chip of claim 1, wherein to determine the communication protocol compatible with the grid entity, the processing element is to scan the compatible communication protocol using a handshake process.

11. The identification power chip of claim 10, wherein the communication protocol comprises at least one of: IEC 61850, IEEE 2030.5, DNP3, or Modbus.

12. The identification power chip of claim 1, wherein the processing element is to switch the communication protocol in response to communicative coupling of the energy device to a different grid entity.

13. The identification power chip of claim 1, wherein to obtain the digital certificate, the processing element is to transmit the UID in a request message to a certifying authority (CA) entity, and receive the digital certificate in response to the request message upon verification.

14. A distributed energy resource (DER) comprising:
an identification power chip having a processing element to:
receive a plurality of electrical parameters associated with the DER from a data acquisition module;
obtain a digital certificate based on a unique identifier (UID) of the DER;
determine a communication protocol compatible with a grid entity;
transmit the plurality of electrical parameters, the UID, and the obtained digital certificate to the grid entity, according to the determined communication protocol;
receive a challenge message from the grid entity based on the transmission; and
upon receiving the challenge message, transmit a signed message to the grid entity using a private key associated with the digital certificate, wherein the signed message is verifiable using a public key in the digital certificate.

15. A method for authenticating an energy device on a grid entity, using the identification power chip, the method comprising:
receiving, from a data acquisition module associated with a processing element, a plurality of electrical parameters of an energy device;
obtaining, by the processing element, a digital certificate based on an unique identifier (UID) of the energy device;
determining, by the processing element, a communication protocol compatible with the grid entity;
transmitting, by the processing element, the plurality of electrical parameters, the UID, and the obtained digital certificate to the grid entity, according to the determined communication protocol;
receiving, by the processing element, a challenge message from the grid entity based on the transmission; and
upon receiving the challenge message, transmitting, by the processing element, a signed message to the grid entity using a private key associated with the digital certificate, wherein the signed message is verifiable using a public key in the digital certificate.
